(19) United States
(12) Patent Application Publication
(10) Pub. No.: US 2013/0249498 A1
(43) Pub. Date: Sep. 26, 2013

(54) NON-AQUEOUS SECONDARY BATTERY AND SECONDARY BATTERY SYSTEM

(71) Applicants: Tsunenori Yamamoto, Hitachi (JP); Keisuke Fujito, Mito (JP)

(72) Inventors: Tsunenori Yamamoto, Hitachi (JP); Keisuke Fujito, Mito (JP)

(73) Assignee: Hitachi, Ltd., Tokyo (JP)

(21) Appl. No.: 13/992,123

(22) PCT Filed: Dec. 8, 2010
(86) PCT No.: PCT/JP2010/007126

§ 371 Date: Jun. 6, 2013

(51) Int. Cl. H01M 2/30; H02J 7/00

(52) U.S. Cl. CPC H01M 2/30; H02J 7/0052
USPC 320/137; 429/149; 429/90

(57) ABSTRACT

A non-aqueous secondary battery, such as a lithium ion secondary battery, eliminates local potential distribution in a cell due to the side reaction during charge/discharge, and does not undergo deterioration of capacitance, deterioration of a positive electrode material, and deposition of metallic lithium. The non-aqueous secondary battery has an electrode group and an electrolyte disposed in one container. The electrode group includes a positive electrode, a negative electrode, and a separator, and is divided into a plurality of electrode groups separated electrically. The electrode groups are in contact with an identical electrolyte, and terminals are led out from the positive electrode and the negative electrode to the outside of the container on every electrode group. Terminals are connected on every positive electrode and negative electrode at the outside of the container, and the terminals at the outside of the container are connectable and disconnectable easily.

### TECHNICAL FIELD

The present invention relates to a non-aqueous secondary battery. The invention more particularly relates to a high energy density lithium ion secondary battery and a power source module thereof suitable to use, for example, in portable equipment, electric cars, power storage, etc.

### BACKGROUND ART

A lithium ion secondary battery uses a carbon material as a negative electrode active material. It is known that in such a secondary battery a solid electrolyte interphase is formed on the surface of a negative electrode due to side reaction accompanying the negative electrode charge reaction during initial charging after the manufacture of the battery. It is also known that the solid electrolyte interphase grows during storage in a circumstance at a relatively high temperature or along with progress of the side reaction on the surface of the negative electrode occurring by subjecting to charge/discharge cycles. The side reaction involves lithium ion intercalation within the negative electrode, which causes degradation of battery characteristics, such as capacitance deterioration due to shift of the potential of the positive and negative electrodes to a higher potential, increase in the resistance attributable to increase in solid electrolyte interphase thickness at the surface of the negative electrode, and the like.

As a prior art for solving the subject, Patent Literature 1 discloses, for example, attachment of lithium to a negative carbon electrode. In the disclosed technique, since lithium attached to the negative carbon electrode dissolves by itself to release ions to the negative carbon electrode, ions deintercalated from the inside of the negative electrode due to the side reaction are compensated. This can return the negative electrode to a low potential to suppress deterioration of capacitance.

Further, Patent Literature 2 describes that lithium is disposed as a third electrode inside a battery, an electrode terminal connected with the third electrode is disposed on the cell surface, the amount of lithium ions deintercalated from the negative electrode is judged based on the potential difference between the third electrode and the negative electrode and those corresponding to lithium ions consumed are supplied. Also this can return the negative electrode to the low potential to suppress deterioration of capacitance.

Further, Patent Literature 3 describes that potential measuring means is disposed between a third electrode and a positive electrode and those corresponding to lithium ions consumed are supplied automatically when the potential difference is at a predetermined level or higher.

On the other hand, Patent Literature 4, Patent Literature 5, and Patent Literature 6 describe configurations in which a plurality of wound electrode bodies are disposed in the inside of a battery with an aim of increasing the capacitance density of lithium ion secondary batteries and improving the safety of the batteries.

### Prior Art Literature

### Patent Literature

### Patent Literature 1: JP-05-234622-A

### Patent Literature 2: JP-08-190934-A

### Patent Literature 3: JP-2007-305475-A

### Patent Literature 4: JP-09-266013-A

### Patent Literature 5: JP-2000-311701-A

### Patent Literature 6: JP-2003-31202-A

### SUMMARY OF THE INVENTION

### Problem to be Solved by the Invention

However, the approach to the supply of lithium ions for the solid electrolyte interphase formation described above is on the premise that the state of occurrence of the side reaction on the surface of the negative electrode and the shift of each of the electrode to higher potential are uniform in the inside of the cell.

It is known that the side reaction on the negative electrode proceeds acceleratingly upon elevation of temperature, increase in the number of charge/discharge cycles, and charge/discharge at high current. One example of situations in which such factors are combined with one another is repetitive charge/discharge of a large-size lithium ion battery cell with a high current applied.

When a lithium ion battery is charged/discharged repetitively under high current, heat is generated by joule heating in the cell due to direct current resistance of the battery. While the generated heat is dissipated from the outer periphery of the cell into air, since heat resistance is present in a central portion and an outer peripheral portion of the cell, the temperature at the central portion of the cell is higher than that of the outer peripheral portion of the cell, particularly, in a large sized cell. In addition, since the direct current resistance is generally lowered along with elevation of temperature in the lithium ion secondary battery, current is concentrated more in the central portion of the cell than in the outer peripheral portion of the cell. As described above, since it is considered that the temperature is higher and the current is larger in the central portion of the cell than those at the outer peripheral portion of the cell, it can be presumed that the side reaction on the surface of the negative electrode of the cell is accelerated more in the central portion of the cell than that in the outer peripheral portion of the cell.

The result of actually charging and discharging a battery cell under a high current is to be described with reference to FIG. 17 to FIG. 22. The battery cell used in the experiment has 40 mm of diameter, 108 mm of length, and 5.5 Ah of electric capacitance. After charge/discharge of the cell is repeated 3000 cycles at a current of 90 A for a charge/discharge time of 90 sec, the cell was disassembled, and a positive electrode and a negative electrode were cutout from a central portion, an intermediate portion, and an outer peripheral portion of the cell as shown in FIG. 19 and charge/discharge characteristics of partial electrodes were investigated.

FIG. 20 illustrates charge/discharge characteristics of an electrode at a central portion, FIG. 21 illustrates charge/discharge characteristics of an electrode at an intermediate portion, and FIG. 22 illustrates charge/discharge characteristics of an electrode at an outer peripheral portion. The abscissa represents a charge/discharge capacity and the ordinate represents a voltage or potential. In the graphs, a curve represented by blank circles (◯) shows a voltage between a positive electrode and a negative electrode, blank trigonals (Δ) show a potential of the positive electrode to lithium inserted as a reference electrode, and blank squares (□) also show the potential of the negative electrode to lithium.

Black rhombuses (♦) show characteristics upon charge/discharge measurement only by the partial electrode of the positive electrode and lithium, and black squares (▪) show characteristics upon charge/discharge measurement only by the partial electrode of the negative electrode and lithium.

According to the graphs, the charge/discharge capacitance is smaller in the electrode at the central portion of the cell than in the electrode at the outer peripheral portion of the cell and both of the positive electrode and the negative electrode are at higher potential. This seems that the side reaction on the surface of the negative electrode is accelerated since the temperature is high and current is concentrated in the central portion of the cell.

FIG. 17 illustrates a presumed charge/discharge state in the initial stage in the outer peripheral portion of the cell and the central portion of the cell. Since the side reaction on the surface of the negative electrode is accelerated due to high temperature and current concentration and lithium ions are deintercalated from the inside of the negative electrode, the negative electrode potential at the central portion of the cell shifts to a higher potential. Since the voltage defined from the outside during charge/discharge is a potential difference between the positive electrode and negative electrode, when the negative electrode is at a high potential, the positive electrode also shifts to a high potential. It can be considered that the charge/discharge state in the central portion of the electrode is as shown in FIG. 18.

Increase in the potential of the electrode at the central portion of the cell, particularly, increase in the potential of the positive electrode is not desired since this cause deterioration, for example, decay of crystals of LiCoO₂ as the positive electrode active material and oxygen deintercalation. Further, when a portion of the electrode material on one identical electrode foil (central portion in this case) is at a high potential, it is necessary that other portion (outer peripheral portion) be at a low potential in order to compensate the potential. Actually, the potential of the partial electrode of the negative electrode at the outer peripheral portion illustrated in FIG. 22 shows an extremely low potential, and metal lithium may possibly deposit to the surface of the negative electrode during charging.

Such a local potential distribution in the cell cannot be detected at all based on the voltage between the positive electrode and negative electrode observed from the outside of the cell and it is impossible also by the voltage detection in a case of using lithium as the third electrode as in Patent Literature 2 and Patent Literature 3.

Further, also in the case of batteries where a plurality of wound electrode bodies are disposed in one identical container as shown in Patent Literature 4 to Patent Literature 6, deterioration sometimes occurs in a manner that the potential is different on each of the wound electrode bodies due to elevation of temperature and current concentration in the central portion. Also in such a case, it cannot be detected from the outside which wound electrode body generates potential difference and what level of the potential difference occurs therein.

The present invention intends to solve such a problem or a subject. That is, the present invention intends to provide a non-aqueous secondary battery such as a lithium ion secondary battery that can eliminate local potential distribution in the inside of a cell due to the side reaction during charge/discharge, and less undergoes deterioration of capacitance, deterioration of a positive electrode material, and deposition of metallic lithium.

### Means for Solving the Problem

According to the present invention, a non-aqueous secondary battery has an electrode group and an electrolyte disposed in one container, the electrode group including a positive electrode, a negative electrode, and a separator, wherein the electrode group is divided into a plurality of electrode groups separated electrically, the electrode groups are in contact with an identical electrolyte, terminals are led out from the positive electrode and the negative electrode to the outside of the container on every electrode groups, the terminals are connected on every positive electrode and negative electrode at the outside of the container, and the terminals at the outside of the container are connectable and disconnectable easily.

Further, each of the terminals of the positive electrodes/negative electrodes may be connected on every electrode groups not at the outside of the container but in the inside of the container in which the terminal are also be connectable and disconnectable easily by operation from the outside.

### Effects of the Invention

The present invention can realize a battery less undergoing deterioration of capacitance and deterioration of positive electrode material, and deposition of metallic lithium, and can provide a secondary battery with long life and high in safety.

### BRIEF DESCRIPTION OF THE DRAWINGS

FIG. 1 is a schematic circuit diagram of a lithium ion secondary battery system in a first embodiment.

FIG. 2 is an upper plan view of the lithium ion secondary battery in the first embodiment.

FIG. 3 is an A-A′ cross sectional view of the lithium ion secondary battery cell in the first embodiment.

FIG. 4 is an A″-A′″ cross sectional view of the lithium ion secondary battery cell in the first embodiment.

FIG. 5 is a schematic circuit diagram of a lithium ion secondary battery system in a second embodiment.

FIG. 6 is an upper plan view of the lithium ion secondary battery in the second embodiment.

FIG. 7 is a B-B′ cross sectional view of the lithium ion secondary battery cell in the second embodiment.

FIG. 8 is a B″-B′″ cross sectional view of the lithium ion secondary battery cell in the second embodiment.

FIG. 9 is a schematic circuit diagram of a lithium ion second battery system in a third embodiment.

FIG. 10 is an upper plan view of the lithium ion secondary battery in the third embodiment.

FIG. 11 is a C-C′ cross sectional view of the lithium ion secondary battery cell in the third embodiment.

FIG. 12 is a C″-C′″ cross sectional view of the lithium ion secondary battery cell in the third embodiment.

FIG. 13 is a schematic circuit diagram of a lithium ion secondary battery system in a fourth embodiment.

FIG. 14 is an upper plan view of the lithium ion secondary battery in the fourth embodiment.

FIG. 15 is a C-C′ cross sectional view of the lithium ion secondary battery cell in the fourth embodiment.

FIG. 16 is a C″-C′″ cross sectional view of the lithium ion secondary battery cell in the fourth embodiment.

FIG. 17 illustrates an initial charge/discharge state of a lithium ion secondary battery cell in an embodiment having a subject.

FIG. 18 is a graph showing a charge/discharge state in an outer peripheral portion after a test for the lithium ion secondary battery cell in the embodiment having the subject.

FIG. 19 is a graph illustrating positions of partial electrodes to be investigated after the disassembly of the lithium ion secondary battery cell in the embodiment having the subject.

FIG. 20 is a graph illustrating charge/discharge characteristics of an electrode in a central portion of the lithium ion secondary battery cell in the embodiment having the subject.

FIG. 21 is a graph illustrating charge/discharge characteristics of an electrode in an intermediate portion of the lithium ion secondary battery cell in the embodiment having the subject.

FIG. 22 is a graph illustrating charge/discharge characteristics of an electrode in the outer peripheral portion of the lithium ion secondary battery cell in the embodiment having the subject.

### MODE FOR CARRYING OUT THE INVENTION

The best mode for practicing the invention will be described below. In the embodiments, description is to be made with reference to an example of a secondary battery in which a sheet-like separator retaining an electrolyte is disposed between a positive electrode and a negative electrode and in which the positive electrode, the separator, the negative electrode and the separator are alternately stacked and wound into a cylindrical form to constitute an electrode group. However, the invention can be practiced also for an electrode group which is stacked without winding.

### FIRST EMBODIMENT

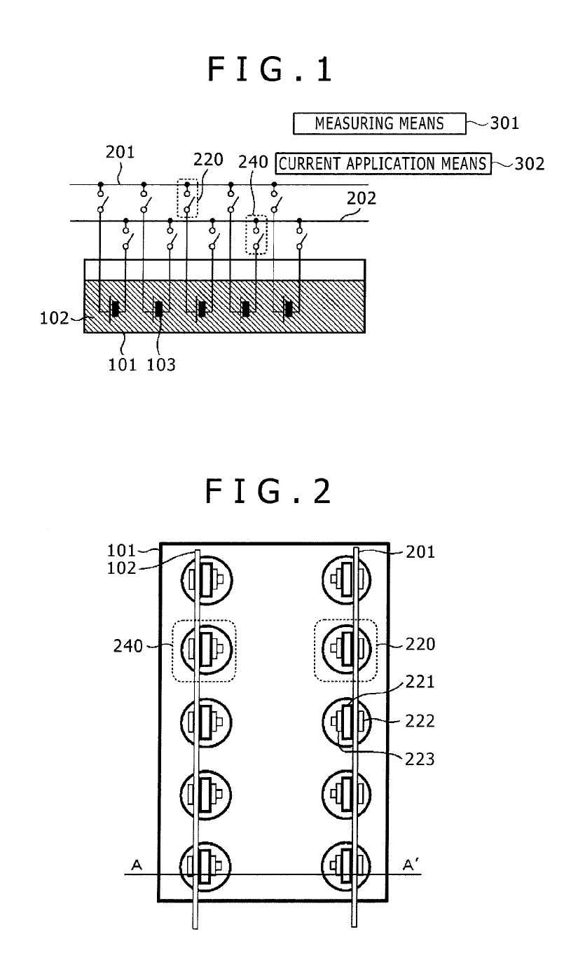

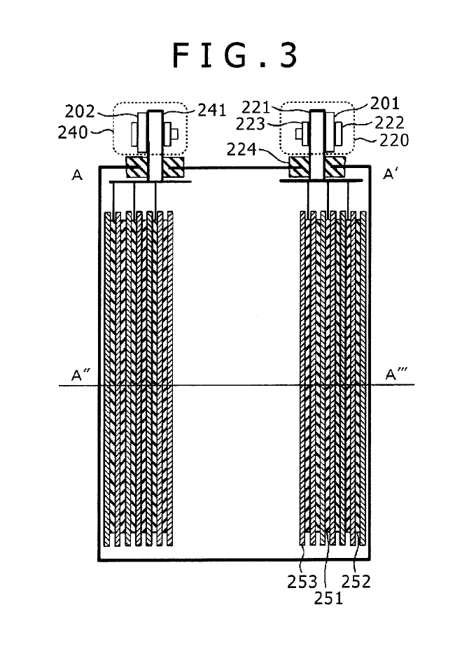

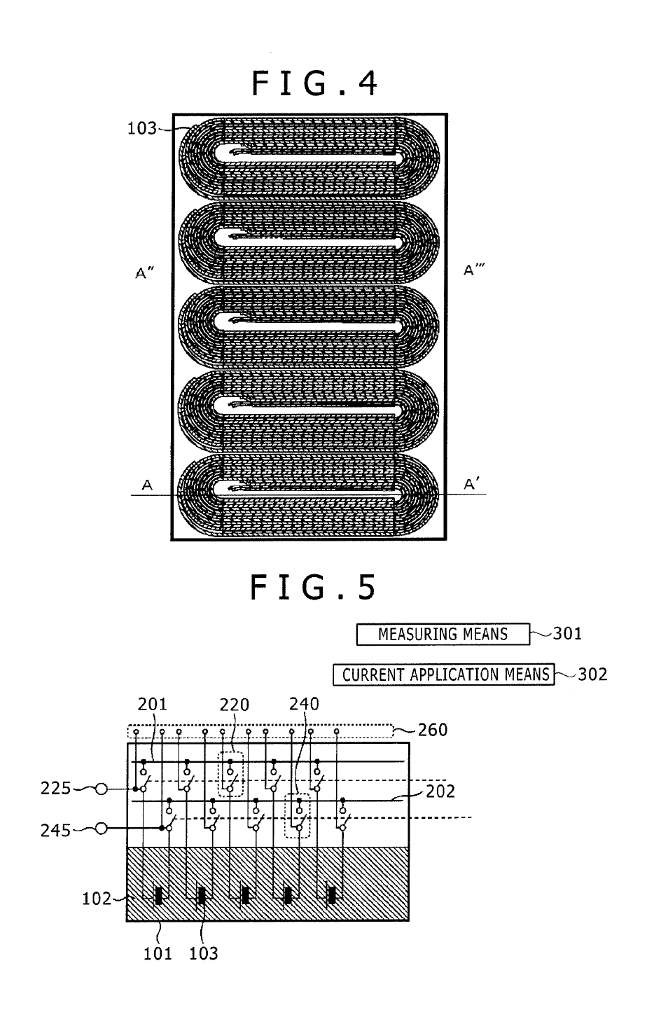

FIG. 1 illustrates a schematic circuit diagram of a secondary battery system having a lithium ion secondary battery in this embodiment, FIG. 2 is an upper plan view of a lithium ion secondary battery in this embodiment, FIG. 3 is an A-A′ cross sectional view in FIG. 2, and FIG. 4 is an A″-A′″ cross sectional view in FIG. 3.

An electrolyte 102 and a plurality of electrode groups 103 are disposed inside a battery container 101. Each of the electrode groups 103 is in contact with an identical electrolyte 102 (dipped therein). The electrode group 103 is formed by alternately stacking a positive electrode 251, a negative electrode 252, and a separator 253 between the positive electrode and the negative electrode and winding them into a flat elliptic shape. Positive electrode terminals 221 and negative electrodes terminals 241 are led out from the positive electrodes 251 and negative electrodes 252 of the respective electrode groups 103 to the outside of the battery container 101. The positive electrode terminals 221 and negative electrodes terminals 241 are connected by way of positive connection opening contacts 220 to a negative electrode bus bar 201 on the positive side and by way of negative electrode connection opening contacts 240 to a negative electrode bus bar 202 on the negative side at the outside of the battery container 101.

The positive electrode connection opening contact 220 has a configuration in which the positive electrode terminal 221 is fastened to the positive electrode bus bar 201 with a bolt 222 and a nut 223 for attachment. In this embodiment, five electrode groups 103 are arranged in the battery container 101 and, for connecting the positive electrode terminals 201 and the negative electrode terminal 241 from each of the electrode groups 103 with the positive electrode bus bar 221 and negative electrode bus bar 202, they are fastened at each of the five points with the bolt 222 and the nut 223.

The positive electrode connection opening contacts 220 and the negative electrode connection opening contacts 240 can be optionally disconnected with the positive electrode terminals 221 and the negative electrode terminal 241 respectively.

In this embodiment, a slurry of a positive electrode mix was prepared by adding LiCoO₂ as a battery positive electrode active material, 7 wt % of acetylene black as an electroconductive agent, and 5 wt % of polyvinylidene fluoride (PVDF) as a binder and admixing N-methyl-2-pyrrolidone to them. After the slurry is coated and dried on both surfaces of a positive electrode foil, i.e., a 25 μm-thick aluminum foil, it was pressed and cut to prepare a positive electrode 251 having a positive electrode material bonded to both surfaces of the positive electrode foil.

Likewise, a slurry of a negative electrode mix was prepared by using less graphitizable carbon as a negative electrode active material, adding 8 wt % of PVDF as a binder, and admixing N-methyl-2-pyrrolidone to them. The negative electrode mix slurry was coated on both surfaces of a negative electrode foil, i.e., a 10 μm-thick copper foil and pressed and cut to prepare a negative electrode 252 having a negative electrode material bonded on both surfaces of the negative electrode foil.

More specifically, LiₓCoO₂, LiₓNiO₂, LiₓMn₂O₄, LiₓFeO₂ (x ranging from 0 to 1), etc. are preferred as the positive electrode material while carbonaceous materials such as graphite and coke having an interlayer graphite spacing of 0.344 nm or less are preferred as the negative electrode active material since they are satisfactory in charge/discharge reversibility. For the electrolyte, it is preferred to use a mixed solvent formed by adding at least one of dimethoxyethane, dienthyl carbonate, dimethyl carbonate, methyl ethyl carbonate, γ-butyrolactone, methyl propionate, and ethyl propionate to ethylene carbonate and an electrolyte of at least one of lithium-containing salts, for example, LiClO₄, LiPF₆, LiBF₄, and LiCF₃SO₃, with a lithium concentration ranging from 0.5 to 2 mol/L.

During normal use of the battery, the lithium ion secondary battery of this embodiment serves to charge/discharge by connecting the positive electrode bus bar 201 and the negative electrode bus bar 202 as each of the terminals of the positive electrodes and the negative electrodes to an external circuit. At every predetermined interval or upon the battery reaching a predetermined electric amount in charge/discharge after starting of the use for charge/discharge, the state of the battery is verified. Specifically, the positive electrode bus bar 201 and the negative electrode bus bar 202 are disconnected from the circuit and the positive electrode terminals 221 are each disconnected from the positive electrode bus bar 201 and the negative electrode terminals 241 are each disconnected from the negative electrode bus bar 202. After that, the potential difference between the positive electrode terminals 221 and that between the negative electrode terminals 241 are measured respectively.

When the potential difference between the electrode terminals 221 and between the negative electrode terminals 241 in each of the electrode groups 103 is not present or present slightly if any, it is regarded that less deterioration due to the formation of the solid electrolyte interphase has proceeded in each of the electrode groups 103. Thus, after the positive electrode terminals 221 and the negative electrode terminals 241 are connected again to the bus bars, the battery is connected to the external circuit for serving to charge/discharge.

By contrast, the potential difference is generated between the positive electrode terminals 221 and between the negative electrode terminals 241, and the potential of positive or negative electrode terminals of the electrode group 103 particularly near the central portion is clearly higher than the potential of the electrode group near the outer periphery. In such cases, it is estimated that deterioration due to the solid electrolyte interphase formation attributable to the side reaction during charge/discharge has proceeded in the electrode group 103 near the central portion.

It is not desired that the positive electrode potential of the electrode group in the central portion increases along with solid electrolyte interphase formation and the potential of the negative electrode group in the outer peripheral portion decreases in order to compensate for the potential since the safety is degraded as described above. To overcome the problem, a current is applied from the external circuit between a positive electrode at a higher potential and a positive electrode at a lower potential and the current is supplied continuously until the potential difference is eliminated substantially. Further, also for the negative electrode, a current is supplied continuously from the external circuit between the negative electrode at a higher potential and the negative electrode at a lower potential until the potential difference is eliminated substantially. Alternatively, the potential difference is eliminated by supplying a current between a positive electrode at a higher potential and a negative electrode at a lower potential until the potential of the positive electrode or the negative electrode reaches a potential identical with that of other electrodes.

The method as described above makes it possible to overcome a state where the potential of the positive electrode is excessively high or the potential of the negative electrode is excessively low in the electrode group 103 in the battery and to recover the safety of the battery. Accordingly, the battery can be connected again to the external circuit and served for charge/discharge.

As has been described above, the present invention makes it possible to open connection of each of the terminals for the positive electrodes and the negative electrodes on every electrode groups. Thus it can be confirmed whether the battery is safe or not by providing a maintenance period in usual use and inspecting the potential difference between each of the terminals for the maintenance period. Further, even if a potential difference is generated inside the battery and the safety is deteriorated, the potential difference can be eliminated by applying the current across the terminals. Thus, local potential difference in the battery can be eliminated and the safety can be recovered; therefore, a battery less undergoing deterioration of capacitance, deterioration of a positive electrode material, and deposition of metallic lithium can be provided.

In this embodiment, five flat wound electrode bodies are used as the electrode group 103, and they are arranged linearly in the battery. However, the electrode group 103 may also be a cylindrical wound type or a stacked type, and the number of the electrode groups may be more than five. The wound electrode bodies may be arranged in the cell not linearly but, for example, cylindrical wound electrode bodies may also be arranged in a closed pack state. Further, in this embodiment, the terminal and the bus bar are fastened by the bolt and the nut for the connection open contacts of each of the terminals, but simpler means such as a threaded hole and a screw may also be used.

A configuration in which the secondary battery includes a measuring means 301 and a current application means 302 is referred to as a secondary battery system. The measuring means 301 is capable of measuring the potential differences between the positive electrode terminals 221 and between the negative electrode terminals 241 respectively. The current application means 302 is capable of applying a current.

### SECOND EMBODIMENT

This embodiment is identical with the first embodiment except for the following point.

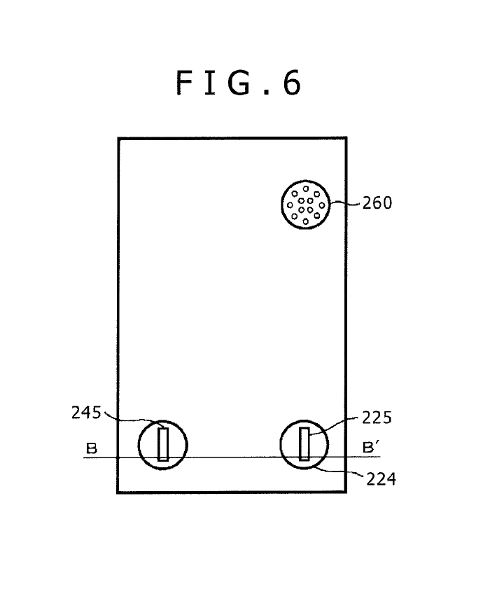

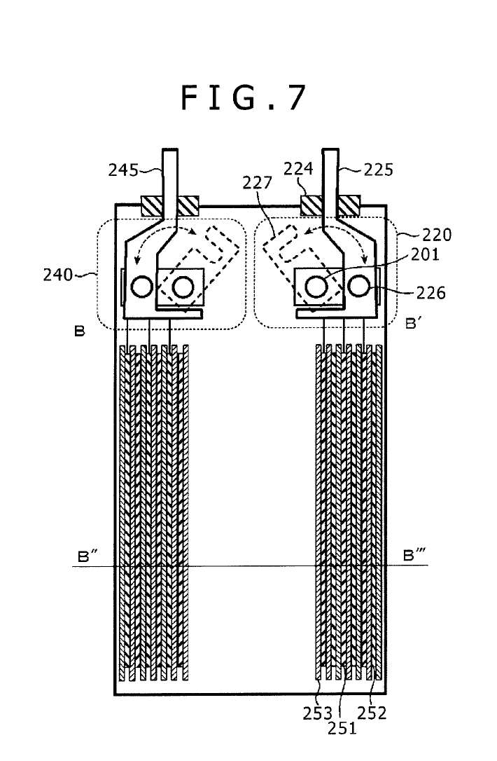

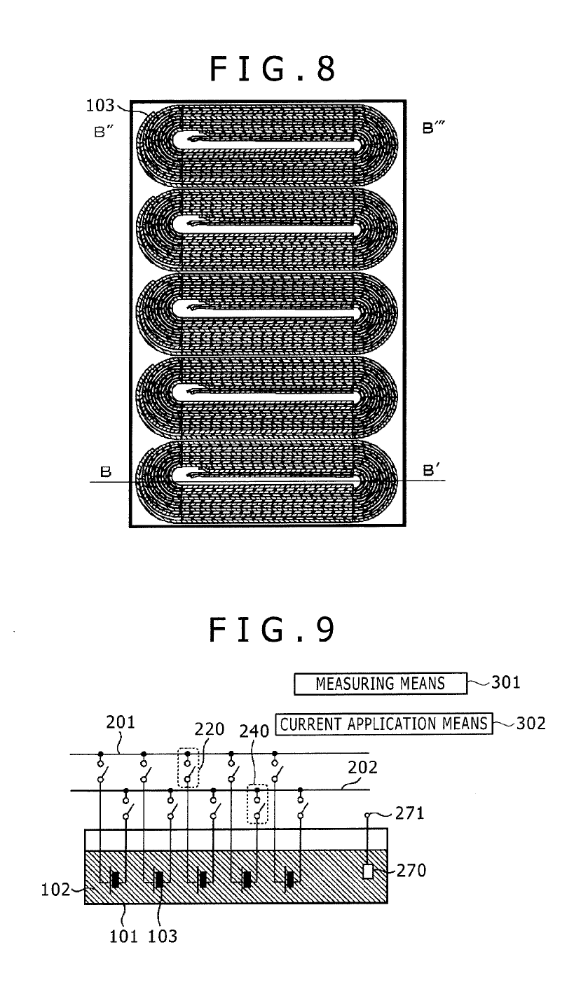

FIG. 5 illustrates a schematic circuit diagram of a lithium ion secondary battery system in this embodiment, FIG. 6 is an upper plan view of a lithium ion secondary battery in this embodiment, FIG. 7 is a B-B′ cross sectional view of FIG. 6, and FIG. 8 is a B″-B′″ cross sectional view of FIG. 7.

This embodiment has a feature that positive electrode connection opening contacts 220 and negative electrode connection opening contacts 240 are in the inside of a battery container 101. As illustrated in FIG. 6, a positive and negative electrode terminal group 260 having terminals assembled for measuring the potential of each of the electrode groups 103 when the connection opening contacts are opened is provided at the exterior of the battery container 101 in addition to the positive electrode charge/discharge terminals 225 and negative electrode charge/discharge terminals 245.

In this embodiment, the positive electrode connection opening contacts 220 and the negative electrode connection opening contacts 240 can disconnect between the positive electrode and negative electrode terminal group 260 in a predetermined state.

The positive electrode connection opening contact 220 in this embodiment includes a terminal plate 227 connected to a positive electrode bus bar 201, a fastening bolt 226, and a counter nut (not illustrated). The positive electrode bus bar 201 is a cylindrical column extended in a direction perpendicular to the plane shown in FIG. 7 and can rotate within a plane parallel to FIG. 7 by a magnetic force from the outside of the battery container 101. The terminal plate 227 is connected to the positive electrode bus bar 201 and moves as shown by an arrow in the drawing in accordance with the rotation of the positive electrode bus bar 201.

The terminal plate 227 has a structure in which a recess thereof fits the fastening bolt 226 when the terminal plate 227 is at a position illustrated by a solid line in FIG. 7. On the other hand, the positive electrode bus bar 201 is completely disconnected from the positive electrode of the electrode group 103 when the terminal plate is at a position illustrated by the dotted line.

On the other hand, also the fastening bolt 226 is a bolt extended in a direction perpendicular to FIG. 7 like the positive electrode bus bar 201 and rotated by a magnetic force from the outside. By fastening the terminal plate 227 provided on every electrode group 103 together with a counter nut (not illustrated) provided on every electrode group 103, the positive electrode of each of the electrode groups 103 and the positive electrode bus bar 201 are connected.

Further, the positive electrode 251 and the negative electrode 252 of each of the electrode groups 103 are connected to each of the terminals of the positive and negative electrode terminal group 260. When the positive electrode connection opening contacts 220 and the negative electrode connection opening contacts 240 are opened, the potential of the positive electrode and the negative electrode of each of the electrode groups 103 can be measured through the positive and negative electrode terminal group 260.

As has been described above, the present embodiment makes it possible to open connection of each of the terminals for the positive electrodes and the negative electrodes on every electrode groups. Thus it can be confirmed whether the battery is safe or not by providing a maintenance period in usual use and inspecting the potential difference between each of the terminals for the maintenance period by using the positive and negative electrode terminal group 260. Further, even if a potential difference is generated inside the battery and the safety is deteriorated, the potential difference can be eliminated by applying the current between the terminals by using positive electrode charge/discharge terminal 225 or the negative electrode charge/discharge terminal 245. Thus, local potential difference in the battery can be eliminated and the safety can be recovered; therefore, a battery less undergoing deterioration of capacitance, deterioration of a positive electrode material, and deposition of metallic lithium can be provided.

A configuration in which the secondary battery includes a measuring means 301 and a current application means 302 is referred to as a secondary battery system. The measuring means 301 is capable of measuring the potential differences between the positive electrode terminals 221 and between the negative electrode terminals 241 respectively. The current application means 302 is capable of applying a current. In this embodiment, the measuring means 301 includes the positive and negative electrode terminal group 260 and the current application means 302 includes the positive electrode charge/discharge terminal 225 or the negative electrode charge/discharge terminal 225.

### THIRD EMBODIMENT

This embodiment is identical with the first embodiment except for the following point.

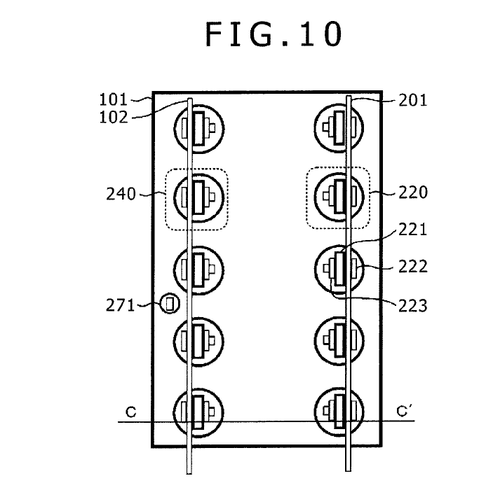

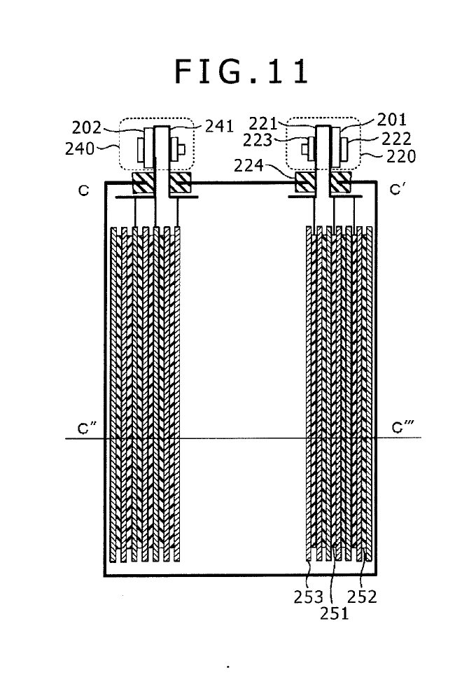

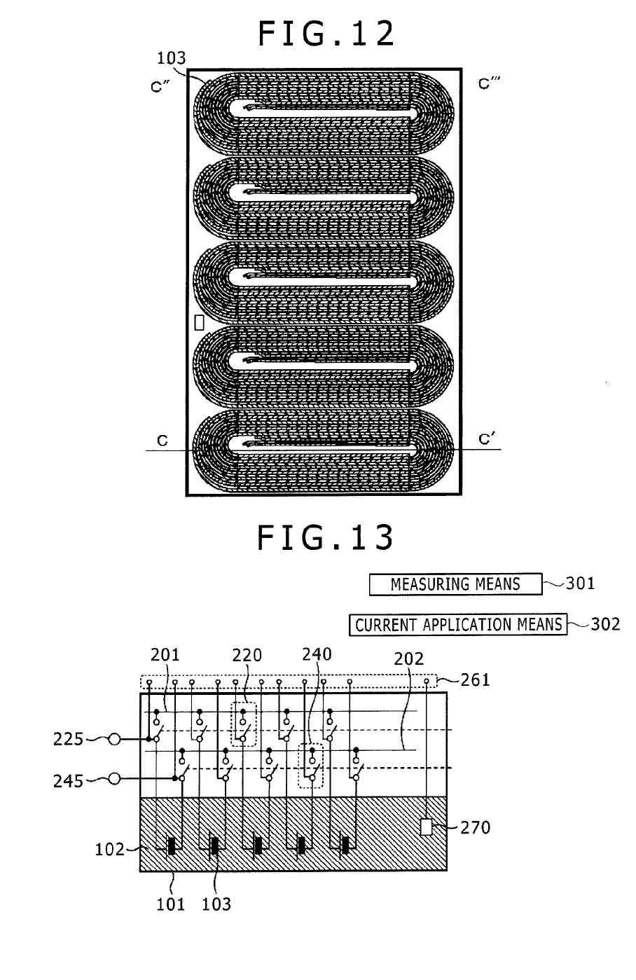

FIG. 9 illustrates a schematic circuit diagram of a lithium ion secondary battery system in this embodiment, FIG. 10 is an upper plan view of the lithium ion secondary battery in this embodiment, FIG. 11 is a C-C′ cross sectional view of FIG. 10, and FIG. 12 is a C″-C′″ cross sectional view of FIG. 12.

This embodiment has a feature that a third electrode 270 is disposed in a battery container 101 so as to be in contact with an electrolyte 102 identical with that for the electrode group 103. The third electrode comprises metallic lithium and a third electrode terminal 271 is disposed outside of the battery container 101 so that the potential can be measured.

This embodiment can measure not only the potential of the positive electrode and the negative electrode of each of the electrode groups 103 as the difference voltage of each of the electrodes as in the first embodiment but also can measure the potential as the potential with reference to the metal lithium. In this case, even if the deterioration proceeds uniformly in all of the electrode groups 103 due to the solid electrolyte interphase formation attributable to the side reaction during charge/discharge, the potential change thereof can be detected.

As has been described above, the present embodiment makes it possible to open connection of each of the terminals for the positive electrodes and the negative electrodes on every electrode groups. Thus it can be confirmed whether the battery is safe or not by providing a maintenance period in usual use and inspecting the potential difference between each of the terminals for the maintenance period. Further, even if a potential difference is generated inside the battery and the safety is deteriorated, the potential difference can be eliminated by applying the current across the terminals. Thus, local potential difference in the battery can be eliminated and the safety can be recovered; therefore, a battery less undergoing deterioration of capacitance, deterioration of a positive electrode material, and deposition of metallic lithium can be provided.

Further, according to this embodiment, even if the inside of the battery deteriorates uniformly and the potential change occurs, since this can be detected by measuring the potential difference relative to the third electrode. Thus the battery with higher safety can be provided.

### FOURTH EMBODIMENT

This embodiment is identical with the second embodiment except for the following point.

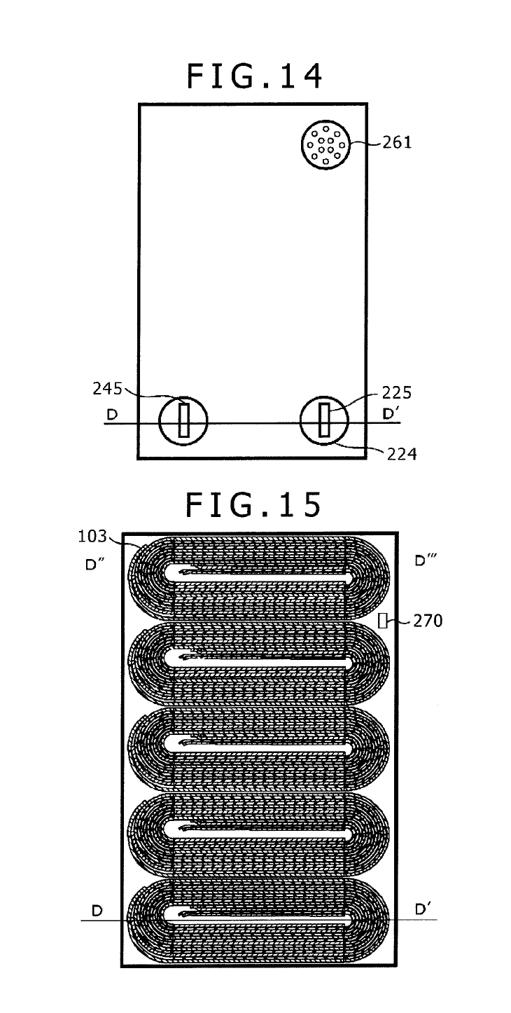

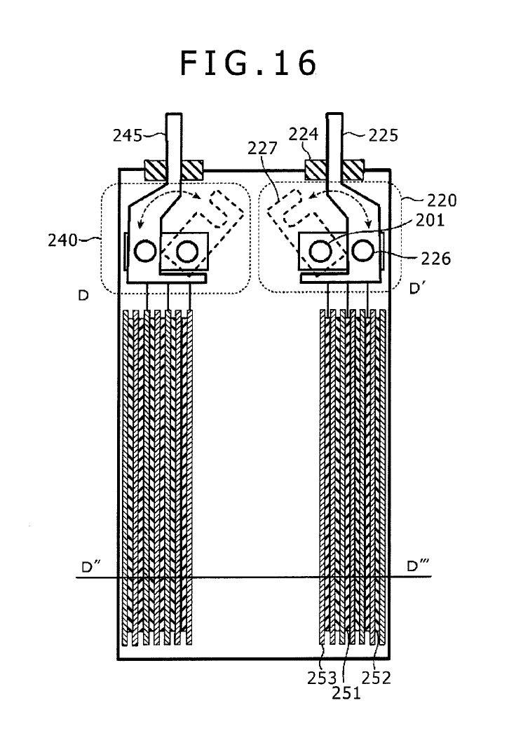

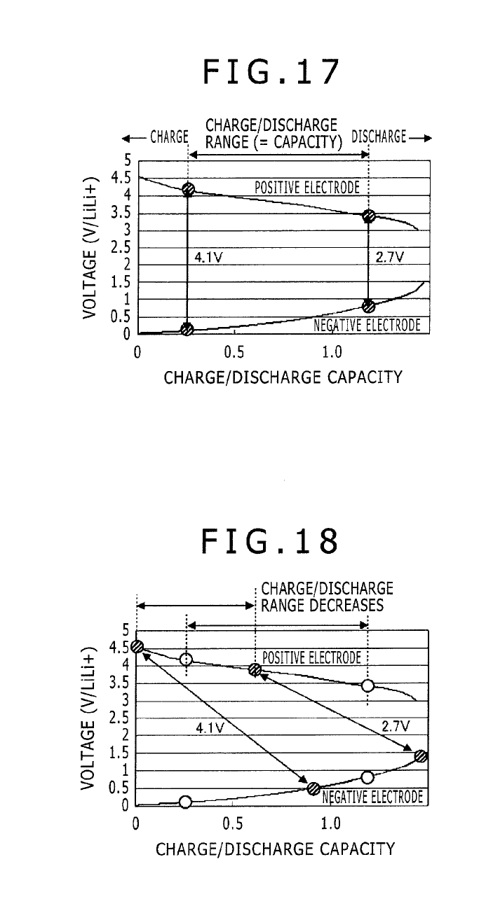

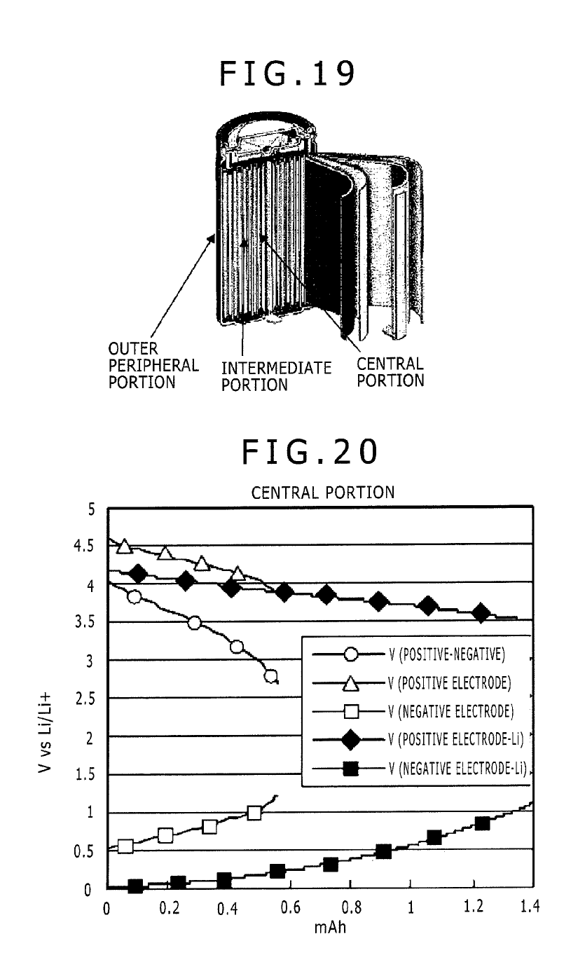

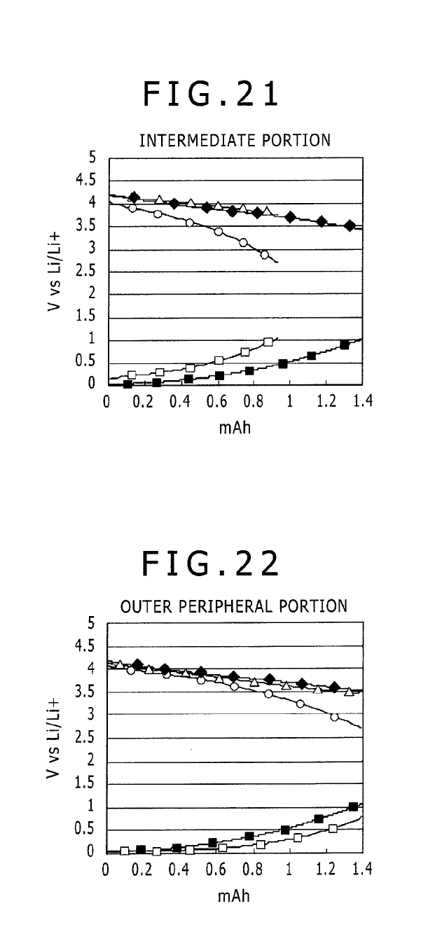

FIG. 13 illustrates a schematic circuit diagram of a lithium ion secondary battery system in this embodiment, FIG. 14 is an upper plan view of a lithium ion secondary battery in this embodiment, FIG. 15 is a D-D′ cross sectional view of FIG. 14, and FIG. 15 is a D″-D′″ cross sectional view of FIG. 16.

This embodiment has a feature that a third electrode 270 is disposed in a battery container 101 so as to be in contact with an electrolyte 102 identical with that for the electrode group 103. The third electrode comprises metallic lithium. The third electrode and one of the positive and negative electrodes and a third electrode terminal group 261 are connected so that the potential can be measured.

This embodiment can measure not only the potential of the positive electrode and the negative electrode of each of the electrode groups 103 as the difference voltage of each of the electrodes as in the second embodiment but also can measure the potential as the potential with reference to the metal lithium. In this case, even when the deterioration proceeds uniformly in all of the electrode groups 103 due to the solid electrolyte interphase formation attributable to the side reaction during charge/discharge, the potential change thereof can be detected.

As has been described above, the present embodiment makes it possible to open connection of each of the terminals for the positive electrodes and the negative electrodes on every electrode groups. Thus it can be confirmed whether the battery is safe or not by providing a maintenance period in usual use and inspecting the potential difference between each of the terminals for the maintenance period. Further, even if a potential difference is generated inside the battery and the safety is deteriorated, the potential difference can be eliminated by applying the current across the terminals. Thus, local potential difference in the battery can be eliminated and the safety can be recovered; therefore, a battery less undergoing deterioration of capacitance, deterioration of a positive electrode material, and deposition of metallic lithium can be provided.

Further, according to this embodiment, even if the inside of the battery deteriorates uniformly and the potential change occurs, since this can be detected by measuring the potential difference relative to the third electrode. Thus the battery with higher safety can be provided.

### DESCRIPTION OF REFERENCE NUMERALS

101 battery container
102 electrolyte
103 electrode group
201 positive electrode bus bar
202 negative electrode bus bar
220 positive electrode connection opening contact
221 positive electrode terminal
222 bolt for attachment
223 nut
224 gasket
225 positive electrode charge/discharge terminal
226 fastening bolt
227 terminal plate
240 negative electrode connection opening contact
241 negative electrode, terminal
245 negative electrode charge/discharge terminal
251 positive electrode
252 negative electrode
253 separator
260 positive and negative electrode terminal group
261 positive and negative electrode and third electrode terminal group
270 third electrode
271 third electrode terminal
301 measuring means
302 current application means

1. A non-aqueous secondary battery having an electrode group and an electrolyte disposed in one container, the electrode group including a positive electrode, a negative electrode, and a separator,
wherein the electrode group is divided into a plurality of electrode groups separated electrically,
the electrode groups are in contact with an identical electrolyte,
terminals are led out from the positive electrode and the negative electrode to the outside of the container on every electrode groups,
the terminals are connected on every positive electrode and negative electrode at the outside of the container, and
a disconnecting device for disconnecting the terminals at the outside of the container is disposed.

2. A non-aqueous secondary battery having an electrode group and an electrolyte disposed in one container, the electrode group including a positive electrode, a negative electrode, and a separator,
the electrode group is divided into a plurality of electrode groups separated electrically,
the electrode groups are in contact with an identical electrolyte,
terminals are led out from the positive electrode and the negative electrode to the outside of the container on every plurality of electrode groups,
the electrode groups are connected on every positive electrode and negative electrode in the container, and
a disconnecting device for disconnecting connection between the electrode groups at the inside of the container is disposed.

3. The non-aqueous secondary battery according to claim 1, wherein
a third electrode different from the electrode group is disposed in the container, and
the terminal of the third electrode is also led to the outside of the container.

4. The non-aqueous secondary battery according to claim 2, wherein
a third electrode different from the electrode group is disposed in the container, and
the terminal of the third electrode is also led out to the outside of the container.

5. A secondary battery system having the non-aqueous secondary battery according to claim 1, wherein
measuring means is provided for measuring the potential difference of the positive electrodes and the negative electrodes on every plurality of electrode groups after the disconnecting device disconnects the terminals at the outside of the container.

6. A secondary battery system having the non-aqueous secondary battery according to claim 2, wherein
measuring means is provided for measuring the potential difference of the positive electrodes and the negative electrodes on every plurality of electrode groups after the disconnecting device disconnects connection between the electrode groups at the inside of the container.

7. A secondary battery system having the non-aqueous secondary battery according to claim 1, wherein
current application means is provided for applying a current from the outside to electrodes across which a potential difference has occurred when the potential difference between the positive electrodes and the potential between the negative electrodes in the electrode groups have reached a threshold value as a result of measurement by the measuring means.

8. A secondary battery system having the non-aqueous secondary battery according to claim 2, wherein
current application means is provided for applying a current from the outside to electrodes across which a potential difference has occurred when the potential difference of the positive electrodes and the negative electrodes between the electrode groups has reached a threshold value as a result of measurement by the measuring means.

9. A secondary battery system having the non-aqueous secondary battery according to claim 3, wherein
measuring means is provided for measuring the potential difference of the positive electrodes and the negative electrode on every plurality of electrode groups after the disconnecting device disconnects the terminals at the outside of the container, and
current application means is provided for applying a current from the outside between an electrode across which a potential difference has occurred and the third electrode when the potential difference of the positive electrodes and the negative electrodes between the electrode groups has reached a threshold value as a result of measurement by the measuring means.

10. A secondary battery system having the non-aqueous secondary battery according to claim 4, wherein
measuring means is provided for measuring the potential difference of the positive electrodes and the negative electrodes on every plurality of electrode groups after the disconnecting device disconnects connection between the electrode groups at the inside of the container, and
current application means is provided for applying a current from the outside between an electrode across which a potential difference has occurred and the third electrode when the potential difference of the positive electrodes and the negative electrodes between the electrode groups has reached a threshold value as a result of measurement by the measuring means.
